(19) United States
(12) Patent Application Publication
(10) Pub. No.: US 2015/0153869 A1
(43) Pub. Date: Jun. 4, 2015

(54) TOUCHSCREEN DEVICE

(71) Applicant: SAMSUNG ELECTRO-MECHANICS CO., LTD., Suwon (KR)

(72) Inventors: Hyun Jun KIM, Suwon (KR); Tah Joon Park, Suwon (KR); Hyun Suk Lee, Suwon (KR); Tae Hyeon Kwon, Suwon (KR)

(73) Assignee: SAMSUNG ELECTRO-MECHANICS CO., LTD., Suwon (KR)

(21) Appl. No.: 14/162,935

(22) Filed: Jan. 24, 2014

(30) Foreign Application Priority Data
Nov. 29, 2013 (KR) 10-2013-0147662

(51) Int. Cl. G06F 3/044

(52) U.S. Cl. CPC G06F 3/044

(57) ABSTRACT

There is provided a touchscreen device, including: a panel unit including a plurality of first electrodes extending in a first direction, and a plurality of second electrodes extending in a second direction intersecting with the first direction; and a control unit simultaneously applying driving signals to alternating predetermined groups of first electrodes and acquiring sensing signals from groups interposed between the alternating predetermined groups, to determine whether a touch has occurred, each of the predetermined groups including a pair of adjacent electrodes of the first electrodes.

### CROSS-REFERENCE TO RELATED APPLICATION

This application claims the benefit of Korean Patent Application No. 10-2013-0147662 filed on Nov. 29, 2013, with the Korean Intellectual Property Office, the disclosure of which is incorporated herein by reference.

### BACKGROUND

The present disclosure relates to a touchscreen device.

A touchscreen device, such as a touchscreen or a touch pad, is a data input device attached to a display device so as to provide an intuitive user interface, and has recently been widely applied to various electronic devices such as cellular phones, personal digital assistants (PDA), and navigation devices. Particularly, as demand for smartphones has been recently increased, touchscreens have been increasingly employed therein, since they provide various input methods in a limited form factor.

Touchscreens used in portable devices may be mainly divided into resistive type touchscreens and capacitive type touchscreens, depending on the way how a touch is sensed thereby. Among these, capacitive type touchscreens have advantages of a relatively long lifespan and ease in implementing various touches and gestures for use therein and thus have been increasingly employed. A multi-touch interface is especially easy to implement in the case of capacitive type touchscreens as compared to resistive type touchscreens, and thus capacitive type touchscreens are widely used in smartphones and the like.

Such capacitive type touchscreens include a plurality of electrodes having a predetermined pattern, the electrodes defining a plurality of nodes in which changes in capacitance are generated due to touches. The nodes deployed on a two-dimensional plane generate changes in self-capacitance or mutual-capacitance due to touches. Coordinates of the touch may be calculated by applying a weighted average method or the like to the changes in capacitance occurring in the nodes.

Patent Document 1 discloses a touchscreen device in which adjacent nodes capacitors are charged with different voltages and a difference between levels of charges stored in the capacitors is obtained to detect changes in capacitance. However, the document fails to disclose detecting changes in capacitance formed between electrodes extending in a single direction.

### RELATED ART DOCUMENT

(Patent Document 1) Korean Patent Laid-Open Publication No. 2011-0103790

### SUMMARY

An aspect of the present disclosure may provide a touchscreen device that applies driving signals to alternating pairs of adjacent electrodes among a plurality of electrodes extending in one direction and acquires sensing signals from the rest of the pairs of the electrodes.

According to an aspect of the present disclosure, a touchscreen device may include: a panel unit including a plurality of first electrodes extending in a first direction, and a plurality of second electrodes extending in a second direction intersecting with the first direction; and a control unit simultaneously applying driving signals to alternating predetermined groups of first electrodes and acquiring sensing signals from groups interposed between the alternating predetermined groups, to determine whether a touch has occurred, each of the predetermined groups including a pair of adjacent electrodes of the first electrodes.

The control unit may apply the driving signals in-phase to the alternating predetermined groups.

The control unit may maintain the plurality of second electrodes in a floating state.

The control unit may identify a location of the touch in the second direction based on the sensing signals.

The control unit may determine whether a touch has occurred based on the sensing signals, the touch being spaced apart from the panel unit by a predetermined distance.

It may be determined whether a proximity touch has occurred based on the sensing signals.

The control unit may include: a driving circuit unit simultaneously applying the driving signals to the alternating predetermined groups; and a sensing circuit unit acquiring the sensing signals from the groups interposed between the alternating predetermined groups.

The control unit may further include: a signal conversion unit converting the sensing signals into digital signals; and an operation unit determining whether a touch has occurred based on the digital signal.

According to another aspect of the present disclosure, a touchscreen device may include: a panel unit including a plurality of first electrodes extending in a first direction; and a control unit determining whether a touch has occurred based on changes in capacitance detected from the plurality of first electrodes, according to a first mode and a second mode repeated at a predetermined interval, wherein: the control unit, in the first mode, simultaneously applies driving signals to alternating predetermined first groups of the first electrodes and acquires sensing signals from first groups interposed between the alternating predetermined first groups; the control unit, in the second mode, applies driving signals to alternating predetermined second groups offset from the first groups by one electrode and acquires sensing signals from second groups interposed between the alternating predetermined second groups; and each of the predetermined first groups includes a pair of adjacent electrodes of the first electrodes.

The control unit may apply the driving signals in-phase to the alternating first and second groups.

The control unit may identify a location of the touch in the second direction intersecting with the first direction in the first and second modes.

The panel unit may further include a plurality of second electrodes extending in a second direction intersecting with the first direction, and the control unit may maintain the plurality of second electrodes in a floating state in the first and second modes.

The control unit may determine whether a touch has occurred based on changes in capacitance detected from the second electrodes, according to a third mode and a fourth mode repeated at a predetermined interval; the control unit, in the third mode, may apply driving signals simultaneously to alternating predetermined third groups in the second electrodes and acquires sensing signals from third groups interposed between the alternating predetermined third group; the control unit, in the fourth mode, may apply driving signals to alternating predetermined fourth groups offset from the third groups by one electrode and acquire sensing signals from fourth groups interposed between the alternating predetermined fourth group; and each of the predetermined third groups includes a pair of adjacent electrodes of the second electrodes.

The control unit may apply the driving signals in-phase to the alternating third and fourth groups.

The control unit may identify a location of the touch in the first direction intersecting with the first direction in the third and fourth modes.

The control unit may maintain the first electrodes in a floating state in the third and fourth modes.

The first to fourth modes may be repeated at a predetermined interval.

The control unit may determine whether a touch has occurred based on the sensing signals acquired in the first to the fourth modes, the touch being spaced apart from the panel unit by a predetermined distance.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view showing an appearance of an electronic device including a touchscreen device according to an exemplary embodiment of the present disclosure;

FIG. 2 is a view of a panel unit included in a touchscreen device according to an exemplary embodiment of the present disclosure;

FIG. 3 is a cross-sectional view of the panel unit illustrated in FIG. 2;

FIG. 4 is a diagram illustrating a touchscreen device according to an exemplary embodiment of the present disclosure;

FIG. 5 is a diagram for illustrating the operation of a touchscreen device in a normal touch mode according to an exemplary embodiment of the present disclosure;

FIGS. 6 and 7 are diagrams for illustrating a scheme of driving a touchscreen device in a proximity touch mode according to an exemplary embodiment of the present disclosure; and

FIGS. 8A through 8D are diagrams for illustrating operation modes of a touchscreen device in a proximity touch mode according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

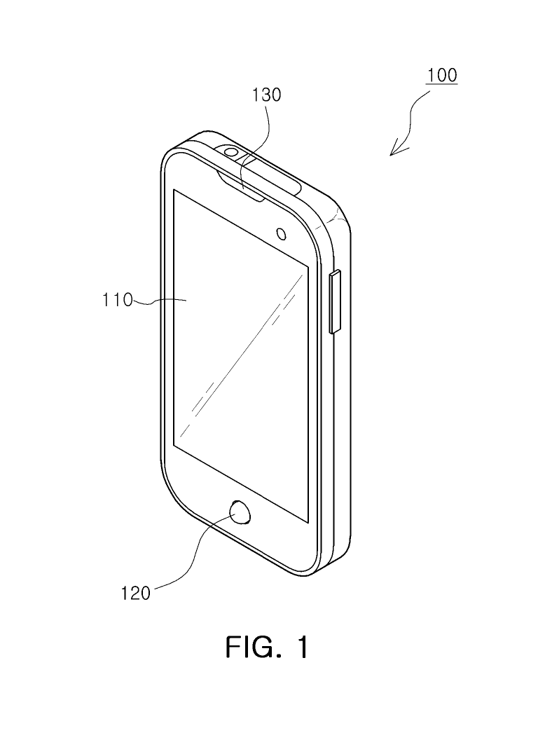

FIG. 1 is a perspective view showing an appearance of an electronic device including a touchscreen device according to an exemplary embodiment of the present disclosure.

Referring to FIG. 1, the electronic device 100 according to the exemplary embodiment may include a display device 110 for displaying a screen, an input unit 120, an audio unit 130 for outputting a voice, and a touchscreen device integrated with the display device 110.

As shown in FIG. 1, it is common in mobile devices that a touchscreen device is integrated with a display device, and such a touchscreen device needs to have a sufficient degree of light transmittance to allow an image displayed on the display device to be viewed by a user. Accordingly, such a touchscreen device maybe implemented on a transparent substrate by forming an electrode thereon with a conductive film formed of a material such as polyethylene terephthalate (PET), polycarbonate (PC), polyethersulfone (PES), polyimide (PI), polymethylmethacrylate (PMMA), a cyclo-olefin polymer (COP), soda glass, or tempered glass. The conductive electrode may be formed of indium tin oxide (ITO), indium zinc oxide (IZO), zinc oxide (ZnO), carbon nano tube (CNT), or graphene, for example. Further, the conductive electrode may be implemented by forming any one of Ag, Al, Cr, Ni, Mo and Cu or an alloy thereof as non-visible fine conductive lines. In a bezel area of the display device, wiring patterns connected to electrodes formed of a transparent, conductive material are arranged, and the wire patterns are shielded by the bezel area so that they are not visible.

Since the touchscreen device according to the exemplary embodiment is of a capacitive type, the touchscreen device may include a plurality of electrodes having a predetermined pattern. Further, the touchscreen device may include a capacitance sensing circuit to sense a change in capacitance formed in the plurality of electrodes, an analog-digital conversion circuit to convert an output signal from the capacitance sensing circuit into a digital value, and an operation circuit to determine whether a touch has occurred using the data converted into digital value.

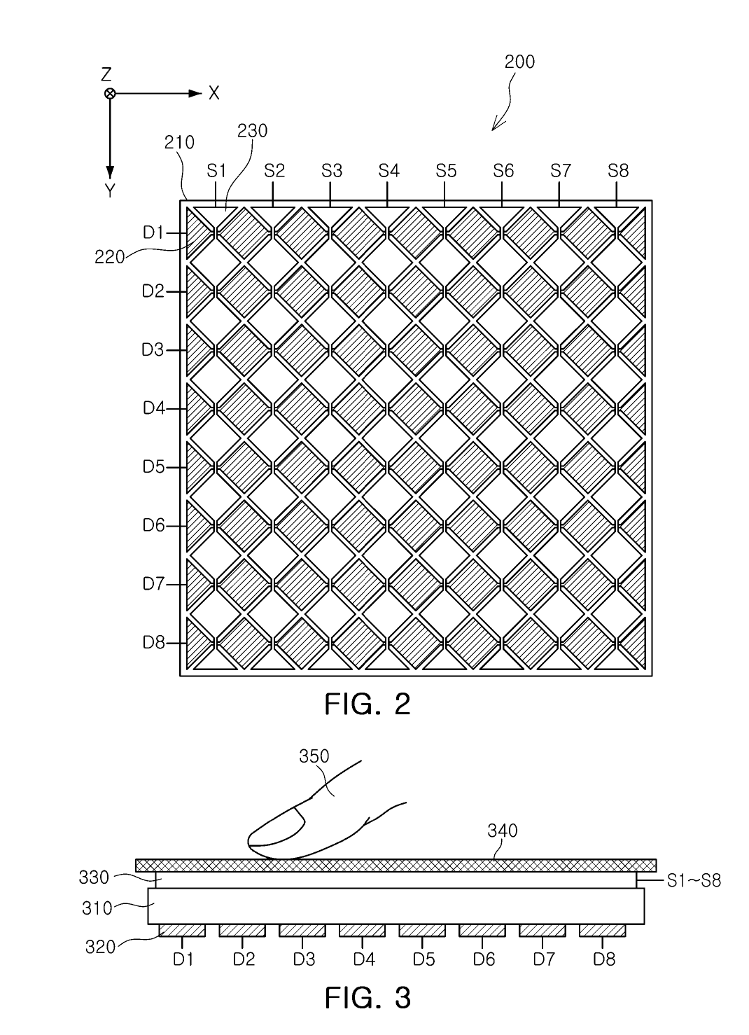

FIG. 2 is a view of a panel unit included in a touchscreen device according to an exemplary embodiment of the present disclosure.

Referring to FIG. 2, the panel unit 200 according to the exemplary embodiment includes a substrate 210 and a plurality of electrodes 220 and 230 provided on the substrate 210. Although not shown in FIG. 2, each of the plurality of electrodes 220 and 230 may be electrically connected to a wiring pattern on a circuit board attached to one end of the substrate 210 through a wiring and a bonding pad. The circuit board may have a controller integrated circuit mounted thereon so as to detect sensing signals generated in the plurality of electrodes 220 and 230 and may determine whether a touch has occurred based on the detected sensing signals.

In a touchscreen device, the substrate 210 may be a transparent substrate on which the plurality of electrodes 220 and 230 are formed. On the region in which wirings for connecting to the plurality of electrodes 220 and 230 are provided, other than the region in which the plurality of electrodes 220 and 230 are provided, a printed region may be formed on the substrate 210 so as to shield the wirings typically formed of an opaque metal material so that they are not visible.

The plurality of electrodes 220 and 230 may be formed on one surface or both surfaces of the substrate 210. Although the plurality of electrodes 220 and 230 are shown to have a lozenge- or diamond-shaped pattern in FIG. 2, it is apparent that the plurality of electrodes 220 and 230 may have a variety of polygonal shapes such as rectangle and triangle.

The plurality of electrodes 220 and 230 may include first electrodes 220 extending in the x-axis direction, and second electrodes 230 extending in the y-axis direction. The first electrodes 220 and the second electrodes 230 may be provided on both surfaces of the substrate 210 or may be provided on different substrates 210 such that they may intersect with each other. If all of the first electrodes 220 and the second electrodes 230 are provided on one surface of the substrate 210, an insulating layer may be partially formed at points of intersection between the first electrodes 220 and the second electrodes 230.

A device, which is electrically connected to the plurality of electrodes 220 and 230 to sense a touch, detects changes in capacitance formed in the plurality of electrodes 220 and 230 by a touch to sense the touch based on the detected change in capacitance. The first electrodes 220 may be connected to channels referred to as D1 to D8 in the controller integrated circuit to receive predetermined driving signals, and the second electrodes 230 may be connected to channels referred to as S1 to S8 in a controller integrated circuit to receive predetermined driving signals. In addition, the channels D1 to D8 and S1 to S8 may be used when the controller integrated circuit detects sensing signals. The controller integrated circuit may acquire changes in capacitance formed between the first electrodes 220 and the second electrodes 230, changes in capacitance formed among the first electrodes 220, and changes in capacitance formed among the second electrodes 230, to use them as sensing signals.

FIG. 3 is a cross-sectional view of the panel unit illustrated in FIG. 2. FIG. 3 is a cross-sectional view of the panel unit 200 illustrated in FIG. 2 taken in the y-z plane, in which the panel unit 200 may further include a cover lens 340 that is touched, in addition to the substrate 310 and the plurality of electrodes 320 and 330 described with reference to FIG. 2. The cover lens 340 may be provided on the second electrodes 330 to receive a touch from a touching object 350 such as a finger.

The first and second electrodes 320 and 330 are formed of a conductive material, and, when a voltage is applied to the first and second electrodes 320 and 330, capacitance may be generated between the first and second electrodes 320 and 330, between the first electrodes 320, and between the second electrodes 330. When a touching object 350 is on or proximate to the cover lens 340, a change in capacitance may occur.

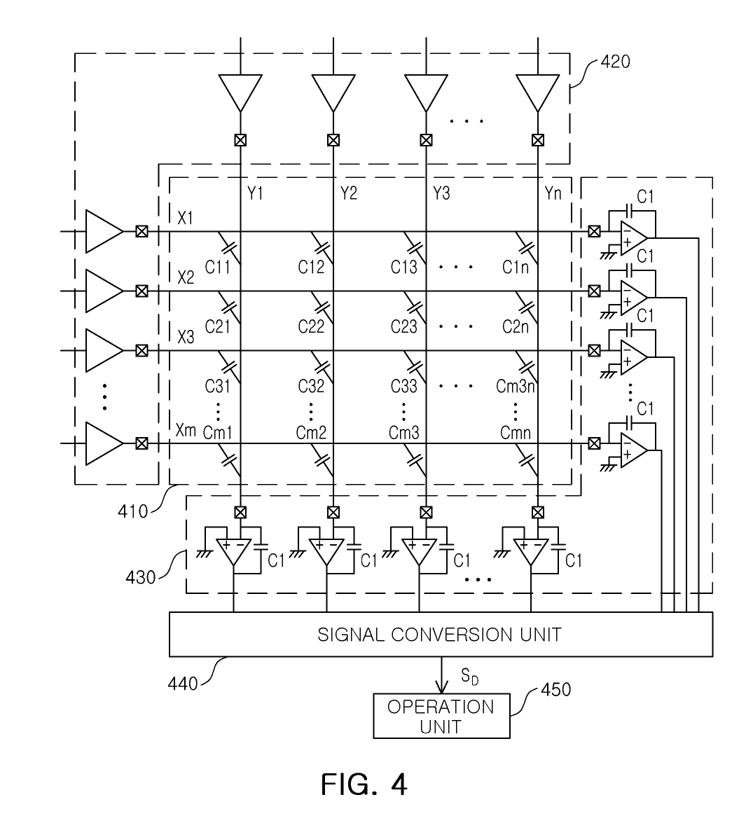

FIG. 4 is a diagram illustrating a touchscreen device according to an exemplary embodiment of the present disclosure.

Referring to FIG. 4, the touchscreen device according to the exemplary embodiment may include a panel unit 410, a driving circuit unit 420, a sensing circuit unit 430, a signal converting unit 440, and an operating unit 450. The driving circuit unit 420, the sensing circuit unit 430, the signal converting unit 440, and the operating unit 450 may be implemented as a single controller integrated circuit (control circuit).

The panel unit 410 may include a plurality of first electrodes X1 to Xm extending in a first axis direction (that is, the horizontal direction of FIG. 4), and a plurality of second electrodes Y1 to Yn extending in a second axis direction (that is, the vertical direction of FIG. 4) crossing the first axis direction.

As described above, when a voltage is applied to a plurality of first electrodes X1 to Xm and a plurality of second electrodes Y1 to Yn, capacitance may be generated, and, in FIG. 4, capacitance occurring in intersections of the plurality of first electrodes X1 to Xm and the plurality of second electrodes Y1 to Yn are denoted by node capacitors C11 to Cmn. Further, although not shown in FIG. 4, it is to be understood that capacitance may also be formed between the first electrodes X1 to Xm and between the second electrodes Y1 to Yn.

The driving circuit unit 420 may apply predetermined driving signals to the first electrodes X1 to Xm and to the second electrodes Y1 to Yn of the panel unit 410. The driving signals may be square wave signals, sine wave signals, triangle wave signals, or the like, having specific frequencies and amplitudes. Although circuits for generating and applying the driving signals are individually connected to the plurality of first and second electrodes X1 to Xm and Y1 to Yn in FIG. 4, it is apparent that a single driving signal generating circuit may be used to apply the driving signals to the plurality of first electrodes by employing a switching circuit.

The sensing circuit unit 430 may be connected to the plurality of first and second electrodes X1 to Xm and Y1 to Yn to receive sensing signals and may detect changes in capacitance based on the received sensing signals. The sensing circuit unit 430 may include C-V converters to detect changes in capacitance as voltage. For example, each of the C-V converters may include at least one operational amplifier and a capacitor Cl having a specific capacitance and may integrate changes in capacitance to output an analog signal in the form of voltage.

The signal conversion unit 440 may generate digital signals S_{D} from the analog signals transmitted from the sensing circuit unit 430. For example, the signal conversion unit 440 may include a time-to-digital converter (TDC) circuit measuring a time in which the analog signals in the form of voltage output from the sensing circuit unit 430 reach a predetermined reference voltage level to convert the measured time into the digital signal S_{D}, or an analog-to digital-converter (ADC) circuit measuring an amount by which a level of the analog signals output from the sensing circuit unit 430 is changed for a predetermined time to convert the changed amount into the digital signal S_{D}.

The operation unit 450 may determine whether a touch has occurred on the panel unit 410 based on the digital signal S_{D}. The operation unit 450 may determine the number of touches, coordinates of the touches, and the type of gesture of the touches or the like on the panel unit 410, based on the digital signal S_{D}.

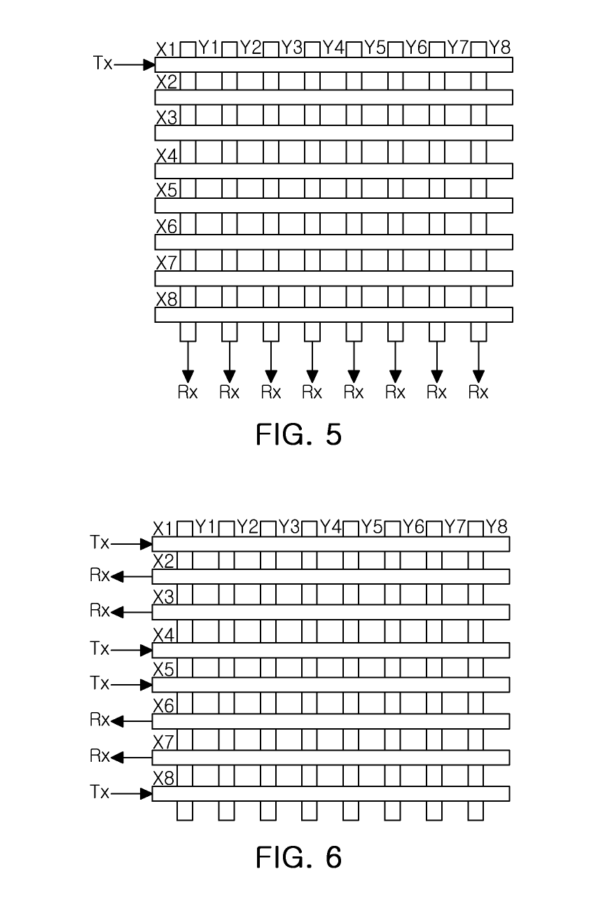

FIGS. 5 through 8 are diagrams for illustrating a scheme of driving a touchscreen device according to an exemplary embodiment of the present disclosure. In FIGS. 5 through 8, the symbol “Tx” refers to a driving signal generated in the driving circuit unit 420 of FIG. 4, and the symbol “Rx” refers to a sensing signal acquired by the sensing circuit unit 430. Although only some of the first and second electrodes X1 to Xm and Y1 to Yn of FIG. 4 are shown in FIGS. 5 through 8 for simplicity, it is apparent that more electrodes may be formed as shown in FIG. 4.

Hereinafter, a scheme of driving a touchscreen device according to the exemplary embodiment will be described with reference to FIGS. 4 through 8.

FIG. 5 is a diagram for illustrating the operation of a touchscreen device in a normal touch mode according to an exemplary embodiment of the present disclosure.

In the normal touch mode, the driving circuit unit 420 may sequentially apply driving signals Tx to the plurality of first electrodes X1 to X8, and the sensing circuit unit 430 may be connected to the second electrodes Y1 to Y8 to acquire sensing signals Rx according to capacitance occurring in intersections of the first electrodes X1 to X8 and the second electrodes Y1 to Y8.

For example, when a driving signal Tx is applied to the first one X1 of the first electrodes, capacitance is formed at intersections of the first one X1 of the first electrodes and the second electrodes Y1 to Y8, such that sensing signals Rx may be acquired from the second electrodes.

It is to be noted that the exemplary embodiments of the present disclosure are not limited thereto. Alternatively, driving signals Tx may be sequentially applied to the second electrodes Y1 to Y8, such that sensing signals Rx may be acquired from the first electrodes X1 to X8.

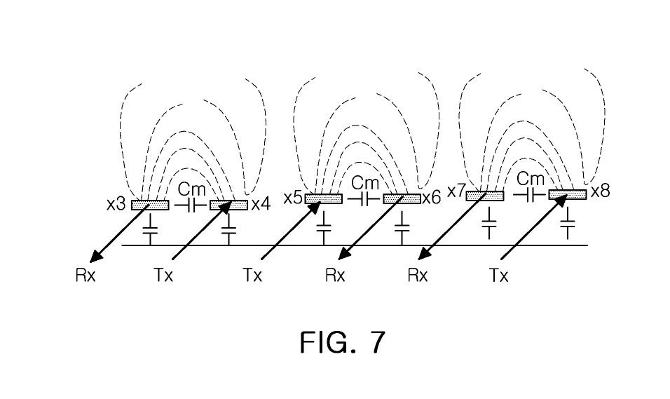

FIGS. 6 and 7 are diagrams for illustrating a scheme of driving a touchscreen device in a proximity touch mode according to an exemplary embodiment of the present disclosure. In the proximity touch mode, the touchscreen device may determine whether a touch has occurred based on capacitance values formed at a pair of adjacent electrodes.

The driving circuit unit 420 may apply driving signals Tx to some of the first electrodes X1 to X8 simultaneously, and the sensing circuit unit 430 may acquire sensing signals Rx from the other ones of the first electrodes X1 to X8 to which the driving signals Tx are not applied.

Assuming a pair of adjacent electrodes among the first electrodes as a group, the first electrodes may include a plurality of groups. The driving circuit unit 420 may apply driving signals Tx simultaneously to every other group among the plurality of groups and may acquire sensing signals Rx from groups interposed between the alternating predetermined groups.

For example, in FIG. 6, assuming that, among the first electrodes X1 to X7, the second and the third ones X2 and X3 form a group, the fourth and the fifth ones form a group, and the sixth and the seventh ones form a group, when driving signals Tx are applied to the fourth and the fifth ones, the sensing signals Rx may be acquired from the second, the third, the sixth, and the seventh ones X2, X3, X6 and X7 of the first electrodes.

Here, the sensing signal Rx acquired from the second one X2 of the first electrodes may be generated according to the capacitance formed between the first and second ones X1 and X2 of the first electrodes, and the sensing signal Rx acquired from the third one X3 of the first electrodes may be generated according to the capacitance formed between the third and the forth ones X3 and X4 of the first electrodes. Likewise, the sensing signal Rx acquired from the sixth one X6 of the first electrodes may be generated according to the capacitance formed between the fifth and sixth ones X5 and X6 of the first electrodes, and the sensing signal Rx acquired from the seventh one X7 of the first electrodes may be generated according to the capacitance formed between the seventh and the eighth ones X7 and X8 of the first electrodes (see FIG. 7).

The driving signals Tx generated in the driving circuit unit 420 may be in-phase. The driving signals in-phase are applied to two adjacent electrodes among the first electrodes, and sensing signals are acquired from the first electrodes on either sides of the two adjacent electrodes, such that electric field coming from the two adjacent electrodes are not superimposed on one another and thus a touch may be precisely detected.

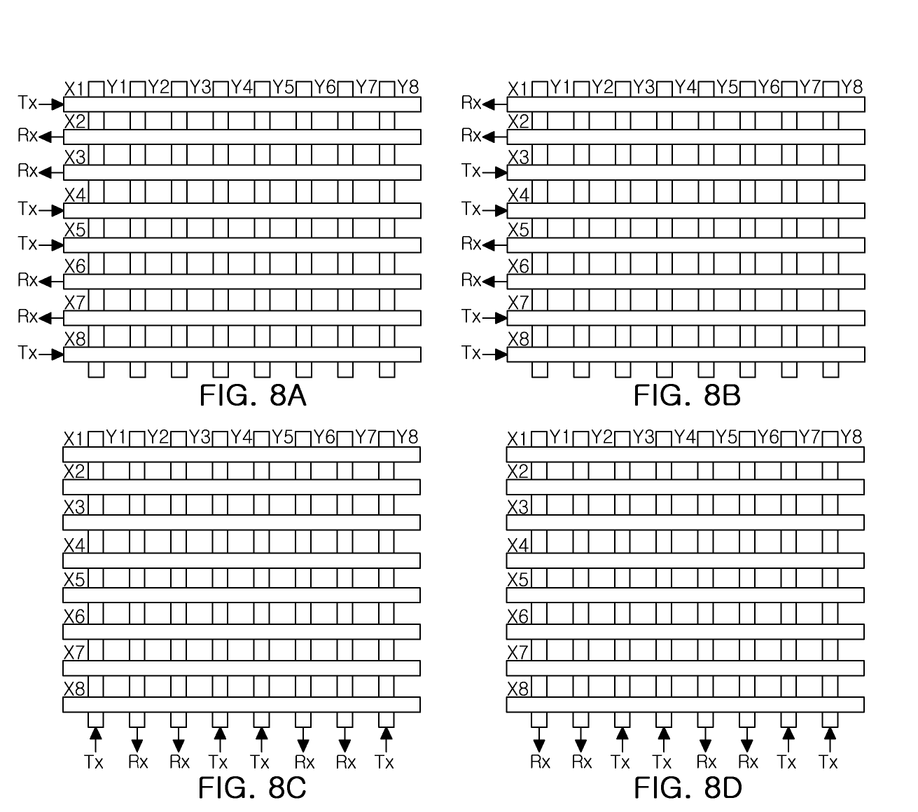

FIGS. 8A through 8D are diagrams for illustrating operation modes of a touchscreen device in a proximity touch mode according to an exemplary embodiment of the present disclosure. The touchscreen device according to the exemplary embodiment may operate in the modes shown in FIGS. 8A through 8D in this order or in other orders. In the following description, the modes shown in FIGS. 8A through 8D are referred to as a first mode to a fourth mode, respectively, for the convenience of illustration.

If driving signals Tx are applied and the sensing signals Rx are acquired in the manner as shown in FIG. 8A, a touch between a pair of first electrodes to which a driving signal Tx is applied such as between the fourth and the fifth ones X4 and X5 of the first electrodes, and a touch between a pair of first electrodes from which a sensing signal Rx is acquired such as between the sixth and the sevens ones X6 and X7 of the first electrodes may not be checked.

According to the exemplary embodiment, after operating in the first mode for a predetermined time period, the touchscreen device may enter the second mode in which an electrode to which a driving signals Tx is applied and an electrode from which a sensing signal Rx is acquired are shifted by one, as shown in FIG. 8B. By doing so, a touch between two electrodes in all of the first electrodes may be precisely checked.

In modes 1 and 2, however, the operation unit 450 may identify the location of a touch in the second direction, i.e., the direction in which the second electrodes extend, but may not identify in the first direction, i.e., the direction in which the first electrodes extend. According to the exemplary embodiment, after operating in modes 1 and 2, the touchscreen device may enter the third mode and the fourth mode in this order such that it operates in the manner shown in FIGS. 8C and 8D, thereby identifying the location of a touch in the first direction.

According to the exemplary embodiment, the second electrodes may be in a floating state in modes 1 and 2, and the first electrodes may be in a floating state in modes 3 and 4. By maintaining the electrodes which are neither driven nor sensed in the floating state, an electric field may be widely formed and thus proximity touch may be more precisely detected.

As set forth above, according to exemplary embodiments of the present disclosure, driving signals are applied to alternating pairs of adjacent electrodes among a plurality of electrodes extending in one direction and sensing signals are acquired from the rest of the pairs of the electrodes, such that a proximity touch, such as hovering, may be precisely detected.

While exemplary embodiments have been shown and described above, it will be apparent to those skilled in the art that modifications and variations could be made without departing from the spirit and scope of the present disclosure as defined by the appended claims.

What is claimed is:

1. A touchscreen device, comprising:
a panel unit including a plurality of first electrodes extending in a first direction, and a plurality of second electrodes extending in a second direction intersecting with the first direction; and
a control unit simultaneously applying driving signals to alternating predetermined groups of first electrodes and acquiring sensing signals from groups interposed between the alternating predetermined groups, to determine whether a touch has occurred, each of the predetermined groups including a pair of adjacent electrodes of the first electrodes.

2. The touchscreen device of claim 1, wherein the control unit applies the driving signals in-phase to alternating predetermined groups.

3. The touchscreen device of claim 1, wherein the control unit maintains the plurality of second electrodes in a floating state.

4. The touchscreen device of claim 1, wherein the control unit identifies a location of the touch in the second direction based on the sensing signals.

5. The touchscreen device of claim 1, wherein the control unit determines whether a touch has occurred based on the sensing signals, the touch being spaced apart from the panel unit by a predetermined distance.

6. The touchscreen device of claim 1, wherein the control unit includes:
a driving circuit unit simultaneously applying the driving signals to the alternating predetermined groups; and
a sensing circuit unit acquiring the sensing signals from the groups interposed between the alternating predetermined groups.

7. The touchscreen device of claim 6, wherein the control unit further includes:
a signal conversion unit converting the sensing signals into digital signals; and
an operation unit determining whether a touch has occurred based on the digital signal.

8. A touchscreen device, comprising:
a panel unit including a plurality of first electrodes extending in a first direction; and
a control unit determining whether a touch has occurred based on changes in capacitance detected from the plurality of first electrodes, according to a first mode and a second mode repeated at a predetermined interval, wherein:
the control unit, in the first mode, simultaneously applies driving signals to alternating predetermined first groups of the first electrodes and acquires sensing signals from first groups interposed between the alternating predetermined first groups;
the control unit, in the second mode, applies driving signals to alternating predetermined second groups offset from the first groups by one electrode and acquires sensing signals from second groups interposed between the alternating predetermined second groups; and
each of the predetermined first groups includes a pair of adjacent electrodes of the first electrodes.

9. The touchscreen device of claim 8, wherein the control unit applies the driving signals in-phase to the alternating predetermined first and second groups.

10. The touchscreen device of claim 8, wherein the control unit identifies a location of the touch in the second direction intersecting with the first direction in the first and second modes.

11. The touchscreen device of claim 8, wherein:
the panel unit further includes a plurality of second electrodes extending in a second direction intersecting with the first direction; and
the control unit maintains the plurality of second electrodes in a floating state in the first and second modes.

12. The touchscreen device of claim 11, wherein:
the control unit determines whether a touch has occurred based on changes in capacitance detected from the second electrodes, according to a third mode and a fourth mode repeated at a predetermined interval;
the control unit, in the third mode, simultaneously applies driving signals to alternating predetermined third groups in the second electrodes and acquires sensing signals from third groups interposed between the alternating predetermined third group;
the control unit, in the fourth mode, applies driving signals to alternating predetermined fourth groups offset from the third groups by one electrode and acquires sensing signals from fourth groups interposed between the alternating predetermined fourth group; and
each of the predetermined third groups includes a pair of adjacent electrodes of the second electrodes.

13. The touchscreen device of claim 12, wherein the control unit applies the driving signals in-phase to the alternating third and fourth groups.

14. The touchscreen device of claim 12, wherein the control unit identifies a location of the touch in the first direction in the third mode and in the fourth mode.

15. The touchscreen device of claim 12, wherein the control unit maintains the first electrodes in a floating state in the third mode and in the fourth mode.

16. The touchscreen device of claim 12, wherein the first to the fourth modes are repeated at a predetermined interval.

17. The touchscreen device of claim 12, wherein the control unit determines whether a touch has occurred based on the sensing signals acquired in the first to the fourth modes, the touch being spaced apart from the panel unit by a predetermined distance.
